(19) United States
(12) Patent Application Publication
(10) Pub. No.: US 2011/0250328 A1
(43) Pub. Date: Oct. 13, 2011

(54) Method for smoking of olives for eating

(75) Inventor: Alice Jaschke-Ferreri, Cerignola FG (IT)

(73) Assignee: LA BELLA DI CERIGNOLA S.COOP.A R.L., Cerignola FG (IT)

(21) Appl. No.: 13/066,049

(22) Filed: Apr. 5, 2011

(30) Foreign Application Priority Data
Apr. 8, 2010 (IT) RM2010A000164

(51) Int. Cl. A23L 1/212; A23B 7/00

(52) U.S. Cl. 426/314; 426/615

(57) ABSTRACT

The present invention refers to a method for olive smoking, comprising the following steps:
pre-treating olives until they reach a salt content comprised between 1 and 4%;
smoking salted olives through exposure to smoke coming from the burning without flame of wood sawdust;
packaging smoked olives.

Further, the invention concerns the smoked olives obtained according to said smoking method.

The present invention refers to a method for smoking of olives for eating.

More particularly the invention is related to a process of the said type, suitable for conferring particular organoleptic properties to olives, without degradation of alimentary properties, and in particular a taste such to differentiate olives treated according to said process from those commercially available, of any variety.

It is known that since long time the smoking process is used in order to confer particular organoleptic characteristic to various types of foods. In particular, among smoked food-farming products commercially currently available in national and international markets, the smoking process is used for meat, fish and cheese.

The smoking is obtained exposing food products to the smoke generated by the slow combustion of sawdust of aromatic woods, according to two types of processes:
cold smoking, involving the food to be heated at a temperature from 20° C. to 45° C. for some days or even weeks;
hot smoking, involving the food to be heated at a temperature from 50° C. to 90° C. for a short time period, generally few hours.

Smoking process imparts antiseptic, anti-oxidant and anti-microbial properties. The appearance and the taste of smoked foods are remarkably modified, resulting in real alternative products than original ones. The foods more frequently subjected to smoking process are fat fish and meat; as to cheese, the smoking is carried out on semi-hard or stretched textured cheeses. The choice of the foods depends also on the necessity that the smoking process can involve an excessive drying of the food, resulting in too much dried product. In particular, for cheese the smoking process must be fast and superficial, so that the cheese remains fresh and wet, with unaltered conservation properties.

In this context the solution according to the present invention is disclosed, with the aim of providing a method for smoking of olives for eating intended for eating, aiming to obtain a completely new food product as to organoleptic, but also integral as to nutritional characteristics, respectively.

These and other results are obtained according to the present invention providing a method for cold smoking of olives for eating using smoke from sawdust burning of olive and/or beech firewood.

Therefore the object of the present invention is to provide a method for smoking of olives for eating suitable to overcome the limits of the solutions according to known technology and obtain previously described technical results.

A further object of the invention is to carry out said method at substantially reduced costs.

Not last object of the invention is also to provide a method for smoking of olives for eating being substantially simple, safe and reliable.

It is therefore, a first specific object of the present invention a method for smoking of olives for eating, comprising the following steps:
pre-treating olives until they reach a salt content comprised between 1 and 4%;
smoking salted olives through exposure to smoke coming from the burning without flame of wood sawdust;
packaging smoked olives.

Preferably, according to the invention, said pre-treating step is performed by changing the content of salt to values comprised between 1 and 4% and subsequent drying; and more preferably said drying occurs by means of the exposure to ambient air, for a time comprised between 2 and 24 hours.

Further, again according to the invention, said smoking step by means of exposure to the smoke coming from the burning without flame of wood sawdust comprises the following substeps:
placing olives on perforated trays;
introducing the olive containing trays into a smoker wherein wood sawdust is burned without flame;
exposing the olives to the smoke coming from burning without flame of wood sawdust at a temperature comprised between 20 and 35° C. and for a time comprised between 2 and 6 hours.

More preferably, according to the present invention, said step of olive placing on perforated trays is performed by uniformly placing olives on a perforated trays to form a maximum of three layers of olives per tray.

Preferably, according to the invention, said step of flame free firewood sawdust burning occurs at a temperature comprised between 20 and 25° C.

Still more preferably, according to the invention, said step of flame free firewood sawdust burning is carried out using sawdust coming from beech-wood and/or olive-wood.

Finally, again according to the present invention, said step of packaging smoked olives is preceded by a step of temporary storing in non-sealed container, using brine as liquid medium, for a maximum time of three days.

The smoked olives obtained according to the smoking method as previously defined represent a further specific object of the present invention.

The invention will be described by an illustrative, but not limitative way, with particular reference to some illustrative examples.

### EXAMPLE 1

### Summary of the Tests Carried Out

In order to verify the suitability of the smoking process according to the present invention, and define the optimal parameters, various tests have been carried out and a summary disclosing the general characteristics of the invention is reported below.

As base product, green or black or unaltered olives have been used. In all cases excellent results have been obtained.

The olives have been preliminarily prepared according to the traditional salting methods and in particular at salt content values from 1 to 4%.

Successively, the olives have been stored in appropriate holed boxes, made of plastic material in order to favour the surface drying at ambient air. The permanence time in the boxes can vary, depending on the atmospheric conditions, from two hours to maximum twenty-four hours.

Then, the olives have been uniformly accommodated on holed trays, made of steel, three being the maximum number of olive layers for a tray and from ten to forty kilograms being the olive amount for tray. Thereafter the trays with olives thereon have been inserted into the smokehouse. The above said number of olive layers on the trays is the preferred one as it allows a uniform distribution of the smoking on all the olives to be obtained. A higher number of layers would result in a lower smoking, but however still acceptable, for the olives placed in the intermediate layers; on the contrary a lower number of olive layers, by subjecting to smoking a lower number of olives in each tray, would result in the necessity of using an higher number of trays, the availability of larger smokehouse, or, as an alternative, to carry out various successive smoking processes for various olive lots.

The sawdust used for smoking has been obtained preferably from beech and/or olive firewood and has been reduced to fine size pieces. Then, the sawdust has been placed, according to a winding line forming a fuse-like element, in a suitable box of the smokehouse, placed on a side of smoking-room and then ignited by means of an electric resistance and slowly burned without flame occurrence. The burned sawdust amount was from 150 to 500 g/h, depending on the amount of treated olives.

Through a duct running from the burner box to the inside of the smokehouse, and due to natural flue draught, the smoke passes through the layers of olives accommodated on the tray, resulting in the smoking of same at temperature from 20 to 35° C. Thus the olives have been subjected to a cold-smoking treatment.

Said olives, stored into the smokehouse, have been smoked over a period of time from minimum two to maximum six hours.

The thus obtained olives have been directly submitted to packaging or temporary stored in non hermetic containers, taking care to use brine as liquid medium, scheduled to be packaged within maximum three days.

In some cases, after smoking the original product displayed little colour variations as result of the smoke activity.

### EXAMPLE 2

### Smoking of Black Olives

240 kg of black olives obtained according to “Californian method” and with 1% salt content have been placed in suitable boxes and left standing to dry for 8 hours.

Then said olives have been accommodated uniformly on eight trays according to three olive layers for each tray.

In the box of the smokehouse placed on a side of the smoking-room sawdust of beech and/or olive firewood has been placed, according to a winding line forming a fuse-like element, then ignited by means of an electric resistance and slowly burned without flame occurrence with smoke generation.

Then the trays with the olives thereon have been inserted into the smokehouse and maintained therein for 4 hours at a temperature of 22° C.

For this operation approximately 400 g/h of firewood sawdust have been used.

Then, obtained olives have been stored within brine, for 20 hours, in plastic containers and successively packaged in cans and jars.

The present invention has been described by an illustrative, but not limitative way, according to preferred embodiments thereof, but it is to be understood that variations and/or modifications can be made by those skilled in the art without departing from the scope thereof as defined according to enclosed claims.

1. Method for olive smoking, comprising the following steps:
pre-treating olives until they reach a salt content comprised between 1 and 4%;
smoking salted olives through exposure to smoke coming from the burning without flame of wood sawdust;
packaging smoked olives.

2. Method for olive smoking according to claim 1, characterised in that said pre-treating step is performed by changing the content of salt to values comprised between 1 and 4% and subsequent drying.

3. Method for olive smoking according to claim 2, characterised in that said drying occurs by means of the exposure to ambient air, for a time comprised between 2 and 24 hours.

4. Method for olive smoking according to claim 1, characterised in that said smoking step by means of exposure to the smoke coming from the burning without flame of wood sawdust comprises the following substeps:
placing olives on perforated trays;
introducing the olive containing trays into a smoker wherein wood sawdust is burned without flame;
exposing the olives to the smoke coming from burning without flame of wood sawdust at a temperature comprised between 20 and 35° C. and for a time comprised between 2 and 6 hours.

5. Method for olive smoking according to claim 4, characterised in that said step of olive placing on perforated trays is performed by uniformly placing olives on a perforated trays to form a maximum of three layers of olives per tray.

6. Method for olive smoking according to claim 4, characterised in that said step of flame free firewood sawdust burning occurs at a temperature comprised between 20 and 25° C.

7. Method for olive smoking according to, claim 4 characterised in that said step of flame free firewood sawdust burning occurs using sawdust coming from beech-wood and/or olive-wood.

8. Method for olive smoking according to claim 1, characterised in that said step of packaging smoked olives is preceded by a step of temporary storing in non-sealed container, using brine as liquid medium, for a maximum time of three days.

9. Smoked olives obtained by means of the smoking method defined in claim 1.
